(19) United States
(12) Patent Application Publication
(10) Pub. No.: US 2005/0235063 A1
(43) Pub. Date: Oct. 20, 2005

(54) Automatic discovery of a networked device

(76) Inventor: Christopher S. Wilson, Sunnyvale, CA (US)

Correspondence Address: MCANDREWS HELD & MALLOY, LTD, 500 WEST MADISON STREET, SUITE 3400, CHICAGO, IL, 60661, US

(21) Appl. No.: 11/107,017

(22) Filed: Apr. 15, 2005

Related U.S. Application Data
(60) Provisional application No. 60/562,598, filed on Apr. 15, 2004.

(51) Int. Cl. G06F 15/16

(52) U.S. Cl. 709/227

(57) ABSTRACT

Aspects of the invention provide one or more methods and systems for automatically discovering and configuring a device that is incorporated into a network. In a representative embodiment, a method of automatically recognizing and configuring a first data processing device that is incorporated into the network comprises viewing and locating a file from one or more files, executing said file by way of a first application to generate a user interface, and inputting one or more configuration parameters using the user interface. In one representative embodiment, a system for recognizing and configuring a first computing device introduced into the network comprises a second computing device communicatively coupled to the network, a memory in the first computing device, one or more files stored in the memory, and one or more applications used for displaying said one or more files over a user interface.

### BACKGROUND OF THE INVENTION

When a data processing or computing device is introduced into a computer network, one or more tasks must be accomplished by a user in order for it to effectively communicate with other devices in the computer network. Often, a user must manually configure the settings of the newly introduced computing device. These tasks may involve a number of complex steps. In addition, the user may need to install one or more software drivers. Acquiring these drivers may be a time consuming task. As a consequence, the user may require additional time in order to analyze the computer network prior to configuring the newly introduced device.

Overall, the complexity of the one or more tasks required may ultimately lead to frustration to a user. Further, the time used by a user to properly configure the newly introduced computing device may result in processing downtime and lost revenue to an organization.

The limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the invention provide a method and system for automatic discovery of a data processing (or computing) device that is incorporated into a network, substantially shown and described in connection with at least one of the following figures, as set forth more completely in the claims. In a representative embodiment, the data processing device that is incorporated into the network comprises a data storage device, such as a network storage device (NAS).

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 illustrates a block diagram of a typical system incorporating the use of a network attached storage device (NAS) in accordance with an embodiment of the invention.

FIG. 2 is a block diagram of a network attached storage device (NAS) in accordance with an embodiment of the invention.

FIG. 3 is a block diagram of an integrated circuit chip that implements one or more functions and/or operations performed by the NAS, in accordance with an embodiment of the invention.

FIG. 4 is an operational flow diagram of the process in which a user interface is generated by an exemplary NAS by way of executing one or more configuration file(s), in accordance with an embodiment of the invention.

FIG. 5 is a Microsoft Windows Explorer screen shot illustrating the directory contents of a NAS having an exemplary default name, Viresh-NAS, in accordance with an embodiment of the invention.

FIG. 6 is a Microsoft Windows Explorer screen shot illustrating configuration files contained within a directory, in accordance with an embodiment of the invention.

FIG. 7 illustrates a Netscape Navigator screen shot of a display indicating that a configuration file is being processed, in accordance with an embodiment of the invention.

FIG. 8 is a Netscape Navigator screen shot that illustrates an exemplary user interface in which a user may input one or more administrative parameters, in accordance with an embodiment of the invention.

### DETAILED DESCRIPTION OF THE INVENTION

Various aspects of the invention provide one or more methods and systems for automatically discovering and configuring a data processing device (or computing device) that is incorporated into a network. The data processing device generates a user interface used by a user to further configure the data processing device. The user interface facilitates performing one or more administrative tasks which initializes the data processing device. The data processing device may comprise a personal computer, PDA, laptop, cellular phone, digital cybercam, digital camera, or the like. In a representative embodiment, the data processing device comprises a data storage device, referred to as a network attached storage device (NAS), as will be more fully described later. The network, for example, may comprise any type of computer network, such as a local area network, wide area network, or a piconetwork.

In a representative embodiment, the user interface may be generated after a data processing device, such as an exemplary NAS, is communicatively coupled to a network containing other data processing devices. In a representative embodiment, the user interface is generated when a file stored within the NAS is executed by control from one of the other data processing devices. In a representative embodiment, the file comprises a configuration file that is recognized by an application, such as Microsoft Windows Explorer, found in a Microsoft Windows operating system. The user interface may comprise a web browser such as Windows Internet Explorer or Netscape Navigator. In a representative embodiment, the NAS acts as a server to serve one or more data or program files to one of the other data processing devices. When the data file is received from the server, it may be used to generate a user interface. The NAS may comprise an http server that serves pages to one of the other data processing devices.

In a representative embodiment, the NAS comprises a common storage device for use by one or more other data processing devices communicatively coupled to the NAS. The NAS is communicatively coupled to the other data processing devices such that the other data processing devices may write to or read from the NAS. Each of the other data processing devices may receive and appropriately display one or more data files using an application. The application may comprise a web browser, such as Microsoft Internet Explorer or Netscape Navigator, for example.

In a representative embodiment, the NAS may store data received by a set-top-box (STB) that employs a personal video recorder (PVR). The data may be received by the NAS by way of a set-top-box (STB) communicatively coupled to a cable modem. The cable modem, of course, receives video programming from a cable operator. In a representative embodiment, the PVR lacks a device that is capable of storing the received data. For example, the PVR may not comprise a hard disk drive. In a representative embodiment, the PVR is implemented without a hard disk drive as a cost saving measure provided to a consumer or purchaser. In addition, one or more PVRs lacking a hard disk drive may “off-load” their data storage function to a NAS. In this fashion, the NAS acts as a virtual PVR hard disk drive to the one or more PVRs. Further, the NAS acts as a centralized storage location or single reservoir for all PVRs within a system or network. In a representative embodiment, the PVRs may be situated in one or more networks and may communicate to the NAS by way of one or more switching devices. The switching devices may comprise routers, switches, and hubs, for example.

In a representative embodiment, the data stored in the NAS comprises audiovisual or multimedia data. The data may comprise any type of video or audio data such as MPEG data generated by a telecommunications carrier such as a cable operator. The NAS is communicatively coupled to one or more data processing devices. The one or more data processing devices may comprise a desktop computer, a laptop computer, a PDA, a cellular phone, a digital camera, a video camcorder, digital recorder or a MP3 player.

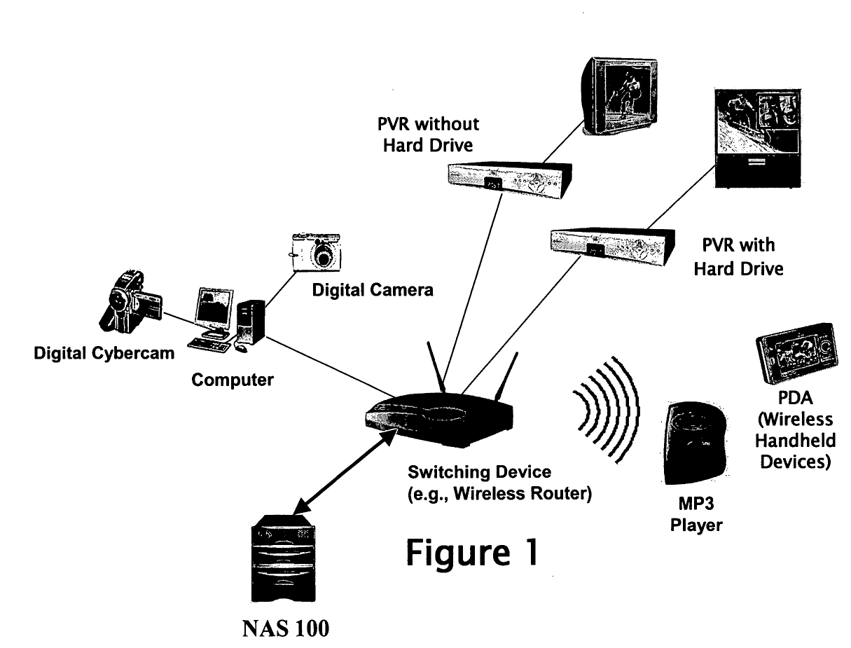

FIG. 1 illustrates a block diagram of a typical system incorporating the use of a NAS 100 in accordance with an embodiment of the invention. The NAS 100 provides data storage for one or more data processing devices. As illustrated, an exemplary switching device provides connectivity of the NAS 100 to the one or more data processing devices. The switching device is capable of providing connectivity using wireless or wireline communications. For example, a wireless router may utilize any one of the following wireless or wireline data communications protocols: 10/100 Ethernet, gigabit Ethernet, 802.11x, Bluetooth, and the like. The one or more data processing devices comprises devices such as a digital cybercam, digital camera, MP3 player, PDA, and one or more personal video recorders (PVRs). As illustrated, the PVR may be equipped with or without a hard disk drive. In a representative embodiment, the PVR may be referred to as a set-top-box (STB) that incorporates personal video recorder capabilities. In this instance, the PVR may be referred to as a PVR-STB. The PVRs are connected to a television or a monitor capable of playing multimedia content to a home user. Use of the NAS 100 provides a centralized storage device for multimedia content received by the one or more PVRs. As a consequence of storing content in a NAS 100, PVRs lacking a storage facility, such as a hard disk drive, may store any data it receives into the NAS 100. Further, any data stored by other data processing devices, including PVRs, may be easily accessed and viewed by any of the one or more data processing devices. For example, a PVR without hard drive may access multimedia content originally stored into the NAS 100 by a PVR with hard drive, and vice-versa. As a result, the NAS 100 facilitates sharing of data among the one or more data processing devices. Since it provides a remote storage mechanism, the NAS 100 may be considered a “virtual storage device” by the one or more data processing devices. The NAS 100 is configured such that its storage capacity may be easily expanded. In a representative embodiment, the NAS 100 may accept additional hard disk drives. As such, the NAS 100 provides an easily scalable and flexible storage mechanism that accommodates for future data storage growth. In addition, the NAS 100 provides data mirroring and data striping capabilities.

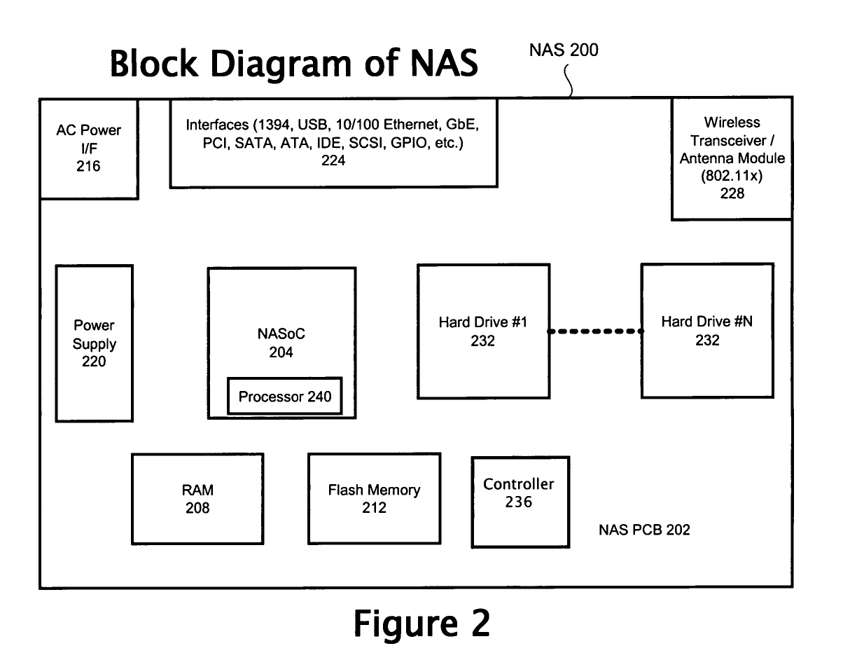

FIG. 2 is a block diagram of a network attached storage device (NAS) 200 in accordance with an embodiment of the invention. The NAS 200 comprises a printed circuit board (NAS PCB) 202 containing one or more components. The one or more components are electrically connected by way of the printed circuit board (PCB) 202. The one or more components comprises a NAS chip (NASoC) 204, a random access memory 208, a flash memory 212, an AC power interface 216, a power supply 220, a block of interfaces 224, a wireless transceiver/antenna module 228, one or more hard disk drives 232, and a controller 236. The interface block 224 may comprise one or more of the following interfaces: IEEE 1394, USB, 10/100 Ethernet, gigabit Ethernet, PCI, SATA, ATA, IDE, SCSI, GPIO, etc.. The wireless transceiver/antenna module 228 may comprise an attachable module or mini-PCI card that may be optionally connected or attached to the NAS' printed circuit board 202. The one or more hard disk drives 232 may comprise any number of hard drives depending on the design of the NAS 200. The printed circuit board 202 may be configured to accommodate an appropriate number of hard disk drives. The number of hard drives utilized may depend on the type of mirroring or data striping (i.e., RAID) provided by the NAS 200. In a representative embodiment, the controller 236 provides control for any one of several devices connected to the NASoC 204. The NASoC 204 may comprise an integrated circuit chip incorporating a processor or central processing unit (CPU) 240.

One or more methods of accessing data stored in the NAS may be accomplished by the NAS executing a software (or firmware) resident in the NAS. The software may be downloaded into a memory of the NAS by way of control provided by, for example, the PC or another data processing or computing device. In a representative embodiment, the memory comprises the flash memory described in reference to FIG. 2. As referenced in FIG. 2, the NAS may comprise a motherboard or printed circuit board (PCB) containing the memory in which the software may be stored. In addition, the PCB may incorporate a processor or CPU that performs the execution of the software resident in the memory. In a representative embodiment, the processor or processing circuitry is implemented within the NASoC previously described.

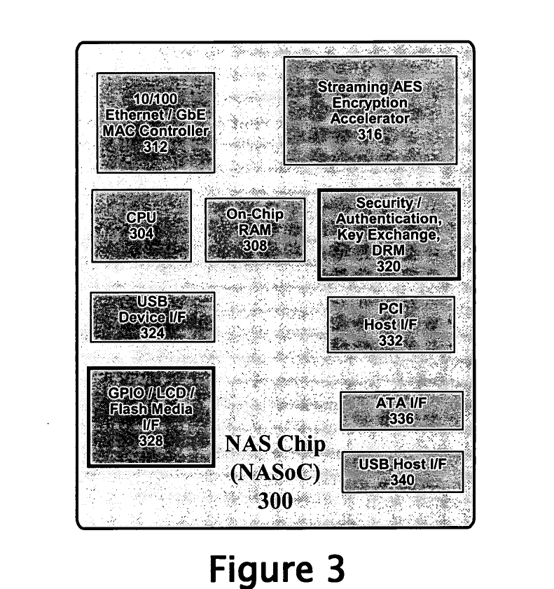

FIG. 3 is a block diagram of an integrated circuit chip (NAS chip or NASoC) 300 that implements one or more functions and/or operations performed by the NAS, in accordance with an embodiment of the invention. The NASoC 300 is mounted on the previously described NAS PCB. The NASoC 300 provides one or more functions that allow the NAS to properly operate. The NASoC 300 comprises a central processing unit (CPU) 304, an on-chip random access memory 308, a Ethernet/MAC controller 312, an encryption accelerator 316, a security/authentication, key exchange, DRM chip 320, and a number of interfaces 324, 328, 332, 336, 340. The interfaces 324, 328, 332, 336, 340 may comprise, for example, the following type of interfaces: USB device I/F 324, a PCI host I/F 332, a GPIO/LCD/flash media I/F 328, an ATA I/F 336, and a USB host I/F 340. The NAS chip 300 (204 in FIG. 2) may communicate and/or connect to the one or more components described in reference to FIG. 2.

Referring back to FIG. 2, the NAS may incorporate varying numbers of hard disk drives depending on its storage and RAID requirements. The NAS 200 chassis may be configured to incorporate 1, 2, 4 or more hard disk drives depending on type of use. For example, the NAS may utilize 4 hard disk drives for implementing RAID 0+1 (both data mirroring and data striping), suitable for use in a small office/business environment. On the other hand, the NAS may utilize only 1 or 2 hard disk drives in a home (or household) environment since the storage capacity utilized is typically less than that utilized in an office or business environment. Referring to FIGS. 2 and 3, memory components 208, 212, 308 utilized in the NAS may be varied depending on type of use. As the data storage requirements increase and as the frequency of data storage related requests increase, the performance of the NAS may be improved to meet its operational needs, by way of increasing memory size of the one or more memories 208, 212, 308 of the NAS. For example, memory capacities may be increased in order to improve the processing performance of the NAS.

In a representative embodiment, a NAS is incorporated into an existing network. The exemplary NAS facilitates the generation of a user interface by serving one or more files to a data processing device. The NAS may act as an http server to serve one or more data files to a data processing device. The data files may be processed by the data processing device such that a user interface is generated. The data processing device acts as a client to the NAS. When served by the exemplary NAS, a user interface is generated at the data processing device such that a user may input one or more values. The user interface may provide one or more fields in which the user may input alphanumeric text. In a representative embodiment, the NAS serves one or more files to a browser application (i.e., such as Internet Explorer or Netscape Navigator). The browser application may reside in a memory (i.e., a storage media such as a hard disk drive) of the data processing device. The browser application generates one or more user interfaces using the one or more files. The one or more user interfaces may comprise a user-friendly graphical user interface (GUI). The graphical user interface displayed by the data processing device may be used to configure the NAS. In a representative embodiment, the processor 240 within the NASoC (204 or 300) may execute software or firmware residing within the RAM 208 or flash memory 212. In a representative embodiment, the user interface that facilitates configuring the NAS is generated when the processor 240 executes software or firmware residing within the RAM 208 or flash memory 212. In a representative embodiment, the software that is executed by the processor 240 comprises a configuration file that is recognized and used by an operating system, such as a Microsoft Windows operating system. In a representative embodiment, the configuration file is capable of being displayed to a user. In a representative embodiment, a user uses the configuration file for completing an initialization procedure on the NAS. In a representative embodiment, the initialization procedure may involve creating one or more authentication passwords that are used in the future for accessing the configuration file. The Microsoft Windows operating system may comprise Windows XP, 2000, ME, 98, Pocket PC, or the like. When the configuration file is executed, by clicking on its filename as displayed by the Windows Explorer application, a user interface is displayed to the data processing device. Thereafter, a user may provide one or more inputs using the user interface to initialize or configure the NAS. The inputs may comprise the following: a name for the NAS, an administration username, an administration password, time, time zone, and network time server internet protocol addresses.

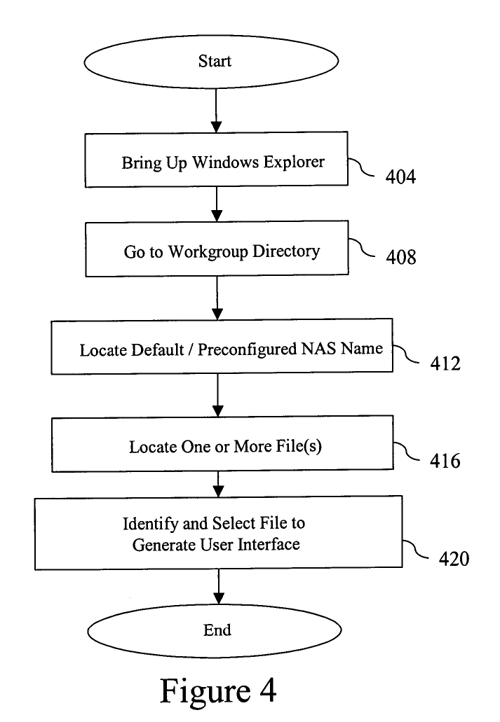

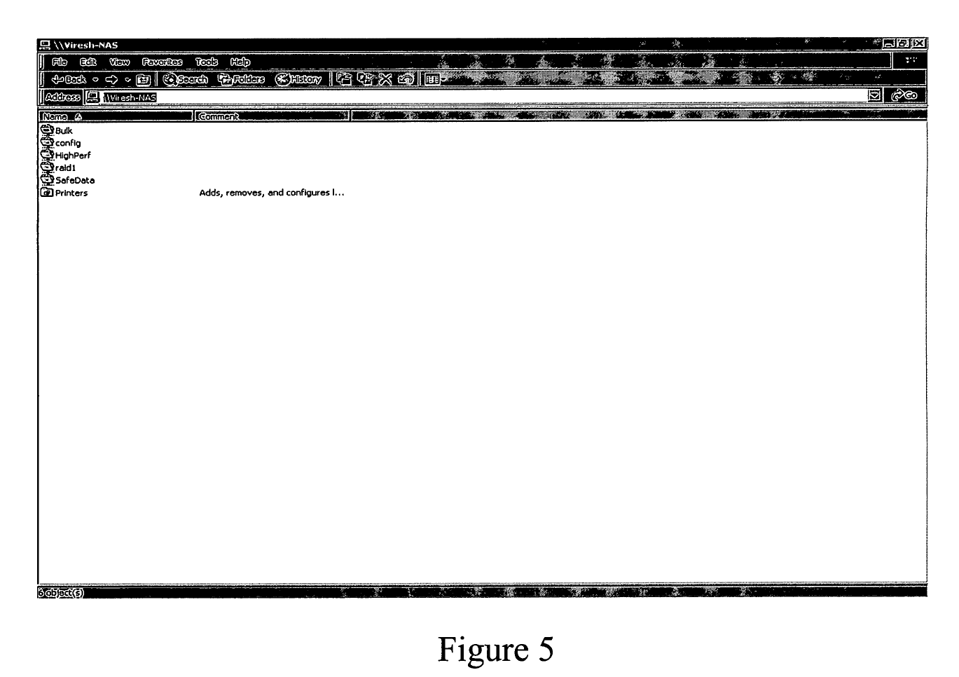

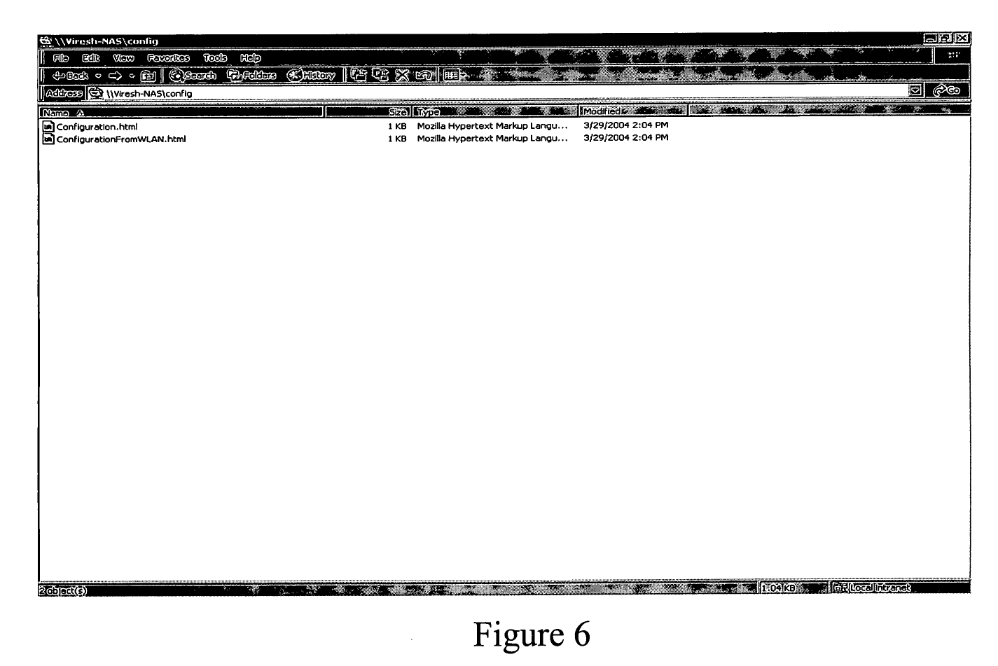

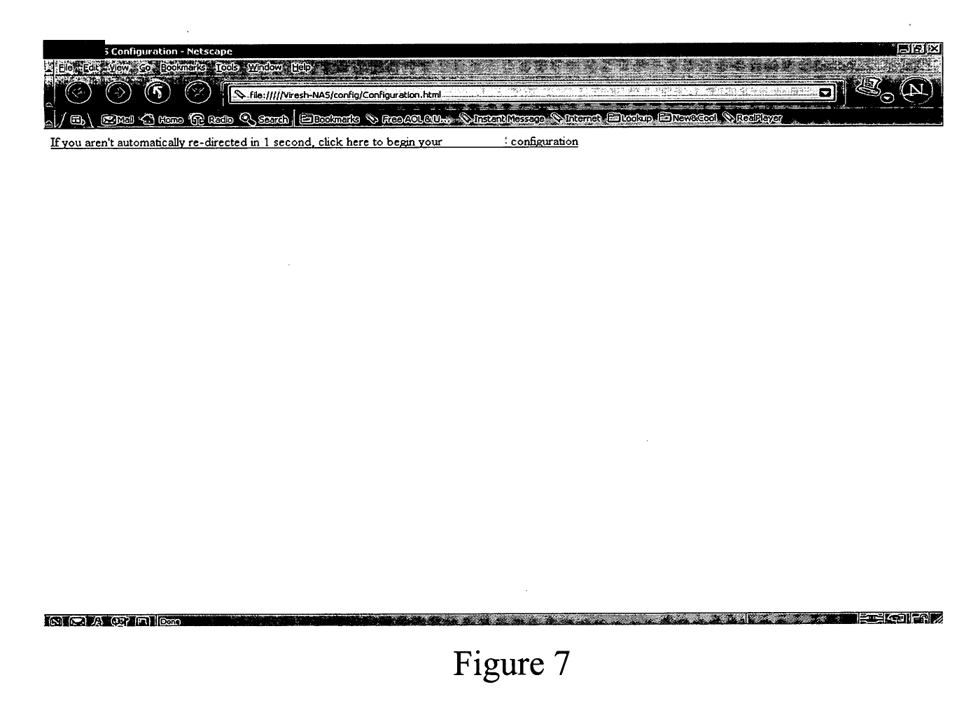

FIG. 4 is an operational flow diagram of the process in which a user interface is generated by an exemplary NAS by way of executing one or more configuration files, in accordance with an embodiment of the invention. At step 404, a user runs an application that allows a user to view one or more data processing or computing devices in a network and their associated directories and files. One such application comprises the Microsoft Windows Explorer application, which may be resident in a memory (i.e., a hard disk drive) of the user's data processing device. The Microsoft Windows Explorer application may be used to view and locate one or more directories and their associated configuration files. At step 408, a directory, such as the Workgroup directory (as may be found in Microsoft Windows Explorer) is accessed by the user, by “clicking” or selecting an identifier using the exemplary Windows Explorer user interface. In a representative embodiment, the Microsoft Windows operating system provides a mechanism that identifies and displays any data processing devices that employ such configuration files. One or more data processing devices containing the one or more configuration files are displayed to the user by way of using Microsoft Windows Explorer, for example. The data processing devices are identified by one or more default names configured when executing the data processing device's software or firmware. At step 412, the user locates and selects a data processing device, such as an exemplary NAS device, by “clicking” on one of the appropriate default NAS name(s) displayed by the Workgroup directory in Windows Explorer, in order to access its configuration file. Of course, the exemplary NAS device must be communicatively coupled to the user's data processing device. In a representative embodiment, the NAS may be communicatively coupled to the user's data processing device by way of a wired local area network. Yet, in another representative embodiment, the NAS may be communicatively coupled to the user's data processing device by way of a wireless local area network. FIG. 5 provides an illustration of Microsoft Windows Explorer in which the directory contents of a NAS having an exemplary default name, Viresh-NAS is shown. It is contemplated that a default name is preconfigured for each NAS at the time of its manufacture. FIG. 5 is a Microsoft Windows Explorer screen shot that illustrates the directory contents of a NAS having an exemplary default name, Viresh-NAS, in accordance with an embodiment of the invention. As illustrated Viresh-NAS comprises the following directories: Bulk, config, HighPerf, raid1, SafeData, and Printers. At step 416, the user locates the appropriate one or more configuration file(s) from the Viresh-NAS\config directory. FIG. 6 is a Microsoft Windows Explorer screen shot illustrating one or more configuration files contained within a directory, in accordance with an embodiment of the invention. As illustrated, the directory, referred to as a Viresh-NAS\config directory comprises two files, Configuration.html and ConfigurationFromWLAN.html. In this representative embodiment, the Configuration.html is associated with setting up the Viresh-NAS over a wired local area network while ConfigurationFromWLAN.html is associated with setting up the Viresh-NAS over a wireless local area network. At step 420, the appropriate one or more configuration file(s) are identified and executed using a device. The device that identifies and executes the one or more configuration file(s) may comprise a mouse, for example. Execution of the one or more configuration file(s) allows an http server (e.g., such as the exemplary NAS), to serve a browser application that resides in an exemplary hard disk drive of another data processing device (e.g., a client computing device). The browser application may comprise Netscape Navigator or Microsoft Internet Explorer, for example. In a representative embodiment, the browser may notify the user that the configuration file is being processed, as illustrated in the representative embodiment of FIG. 7. FIG. 7 illustrates a Netscape Navigator screen shot of a display indicating that the configuration file is being processed, in accordance with an embodiment of the invention. Thereafter, Viresh-NAS generates a user interface (by way of a file served to the client data processing device) that allows the user to properly configure the NAS.

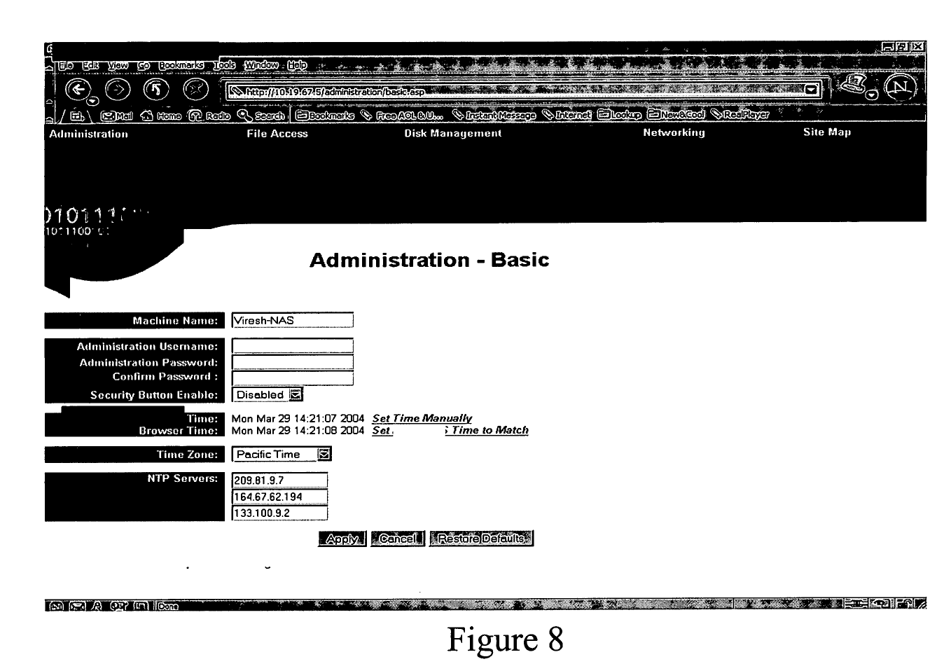

FIG. 8 is a Netscape Navigator screen shot that illustrates an exemplary user interface in which a user configures an exemplary data processing device (such as a NAS), by way of inputting one or more values or parameters, in accordance with an embodiment of the invention. The one or more values may comprise a name for a NAS, an administration username, an administration password, one or more alternate security actuators, time, time zone, and network time server internet protocol addresses. By inputting the one or more values or administrative parameters associated with the NAS, the NAS may be easily identified by way of a preferred name. In addition, the NAS may be time synchronized with one or more data processing or computing devices, such as one or more NTP time servers. For example, use of the administration password prevents unauthorized access to the NAS by an unauthorized user.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method of automatically recognizing and facilitating the configuration of a first data processing device that is incorporated into a network, said method comprising:
communicatively coupling said first data processing device into said network;
first identifying said first data processing device using an application resident in a second data processing device, said application capable of viewing said first data processing device, its one or more directories, and its one or more files;
second identifying a file from said one or more files using said application; and
executing said file by way of said application to generate a user interface in said second data processing device.

2. The method of claim 1 wherein said first data processing device comprises a data storage device.

3. The method of claim 2 wherein said data storage device comprises one or more hard disk drives

4. The method of claim 2 wherein said data storage device is used as a centralized storage facility for one or more data processing devices communicatively coupled to said data storage device.

5. The method of claim 1 wherein said first application comprises Microsoft Windows Explorer.

6. The method of claim 1 wherein said network comprises a local area network.

7. The method of claim 1 wherein said network comprises a wide area network.

8. The method of claim 1 wherein said executing said file is performed using a processor, said processor resident in said first data processing device.

9. The method of claim 1 wherein said user interface is generated by way of serving one or more files from said first data processing device to said second data processing device.

10. The method of claim 9 wherein said second data processing device executes a second application for processing and displaying said one or more files provided by said http server when said one or more files is received by said second application.

11. The method of claim 10 wherein said second application comprises a web browser used for said displaying said one or more files provided by said http server.

12. The method of claim 11 wherein said web browser comprises Microsoft Internet Explorer.

13. The method of claim 11 wherein said web browser comprises Netscape Navigator.

14. A method of automatically discovering a computing device introduced into a network comprising:
first identifying said computing device using a first application;
second identifying a file stored within said computing device using said first application; and
executing said file to generate a user interface using a second application.

15. The method of claim 14 wherein said computing device comprises a data storage device.

16. The method of claim 15 wherein said data storage device comprises one or more hard disk drives.

17. The method of claim 14 wherein said first application comprises Microsoft Windows Explorer.

18. The method of claim 14 wherein said second application comprises a web browser.

19. The method of claim 18 wherein said web browser comprises Microsoft Internet Explorer.

20. The method of claim 18 wherein said web browser comprises Netscape Navigator.

21. The method of claim 14 wherein said executing said file is performed by a processor within said computing device.

22. The method of claim 14 wherein said one or more parameters identifies said computing device.

23. The method of claim 14 wherein said one or more parameters associates a time and time zone for said computing device.

24. A system for identifying a first computing device introduced into a computer network, said system comprising:
a memory in said first computing device;
one or more files stored in said memory of said first computing device;
a second computing device communicatively coupled to said computer network;
a first application resident in a hard disk drive of said second computing device, said first application capable of viewing said one or more files, said second computing device used to identify and initiate execution of said one or more files using said first application; and
a second application resident in said hard disk drive of said second computing device used for displaying said one or more files when said one or more files are received from said first computing device.

25. The system of claim 24 wherein said first computing device comprises a data storage device.

26. The system of claim 25 wherein said data storage device comprises one or more hard disk drives.

27. The system of claim 25 wherein said memory comprises a flash memory.

28. The system of claim 25 wherein said first application comprises Microsoft Windows Explorer.

29. The system of claim 25 wherein said second application comprises a web browser.

30. The system of claim 29 wherein said web browser comprises Microsoft Internet Explorer.

31. The system of claim 29 wherein said web browser comprises Netscape Navigator.

32. The system of claim 24 wherein said device comprises a mouse.
